(19) United States
(12) Patent Application Publication
(10) Pub. No.: US 2008/0235169 A1
(43) Pub. Date: Sep. 25, 2008

(54) Protective, Compact Cover for Topographic Maps and Other Large-Format Documents

(76) Inventor: Dan DeFrance, Bozeman, MT (US)

Correspondence Address: GREENBERG & LIEBERMAN, LLC, 2141 WISCONSIN AVE, N.W., SUITE C-2, WASHINGTON, DC, 20007, US

(21) Appl. No.: 11/690,641

(22) Filed: Mar. 23, 2007

(51) Int. Cl. G06E 1/00

(52) U.S. Cl. 706/16

(57) ABSTRACT

This folding, compact document cover is an apparatus that practically and conveniently protects a specially folded U.S. Geological Survey (USGS) topographic map or virtually any other large-format document with its French-folded binding and easy to handle protective element that is capable of allowing the reader to flip between quadrants without the hassle of continued folding and refolding or rolling and unrolling.

### FIELD OF THE INVENTION

The present invention relates primarily to a durable, relatively stiff material that can be folded in pre-selected quadrants in relation to the horizontal and vertical axis and is sized to fully cover topographic maps or other large format document including, but not limited to, blueprints, poster-sized brochures and technical drawings. The present invention also consists of four corner pockets to help facilitate the folding process.

### BACKGROUND OF THE PRESENT INVENTION

Topographic map-readers rely on much more detail than mere contours. Detailed symbols representing such items as streets, buildings, hills, ridges and vegetation all provide a reader with a well-defined and intimate knowledge of virtually every aspect of the terrain in question. Topographic maps are vital to those who need to know much more than just how to travel from point A to point B. These maps often have precise detail and in the case of the USGS topographic maps, are sized to include certain defined areas. Because of this enhanced view of the selected terrain, people ranging from outdoorsmen to law enforcement and military often rely on topographic maps. The array of people and occupations that use these maps are indeed endless.

While it may be practical for a mission planner to view a topographic map on a large table inside a building while preparing for a movement through desired terrain, it is clearly not the best solution to bring the map on the trip. Many people can relate to the notion of “fighting with the map.” This includes constantly folding it and positioning the map in order to find the correct area of view. Maps crinkle and are quite bulky to keep folding. Because many maps are difficult to fold properly, the issue becomes even more complicated. For a reader out in the field, the map issue is even more prevalent. It is not always practical to lay the map on the ground as this causes time delays and further exposes the map to elements such as dirt and moisture. At the same time, folding through the map in order to find the correct grid coordinate or other desired item also causes distractions and undue hardship if attempted while on the move. Especially in the case of USGS topographic maps, these scenarios have proven to be burdensome and sometimes even hazardous. Topographic maps convey even the most minute of detail for terrains ranging from woodlands to mountains to deserts. Because of the vital information contained in these topographic maps, these maps must also be taken into the very climates that they provide information about.

Realizing maps and other like materials need to be protected from the wide range of elements involved in a field mission, people have come up with some attempts to remedy the situations. For example, page covers have been used to protect each individual page of a map book in a waterproof covering. Others simply have attempted lamination and other quick fixes to protect the map. Another design utilizes a clipboard where a document or map can be attached and then covered by a waterproof material.

However, none of these attempts have applied to the folio sized USGS topographic maps or other large-format documents such as blueprints and technical drawings. These items do not have pages but are traditionally folded and refolded in order to reduce their sizes and provide for better attempts at reading. The size and paper material of items like topographic maps also make them vulnerable to elements such as mud and water. Even if covered by a laminate or other existing method, the issues of folding will still cause hardship as the reader struggles with the topographic map or other large-format document in order to sift through its details to find the desired area of interest. With topographic maps, a reader often must use some ground feature to determine his or her location. This often requires constant folding and maneuvering. Also, a reader must consider the safety of his map with regard to weather conditions or other factors.

There is a need for a folding, waterproof cover specifically designed for USGS topographic maps or other large-format documents that permits the reader to flip from one quadrant to another without unfolding and refolding or rolling and unrolling. In essence, this need is for an apparatus that takes away the “fighting with the map” element that currently exists with respect to USGS topographic maps and other large-format documents. USGS topographic maps are inherently difficult to properly fold without instruction and usually are not folded to the point where it is easy to read. And even if the topographic map is folded the correct way, it is still subject to the elements. A folding, waterproof topographic map cover such as this would make it much safer and more efficient for the reader because he or she would be carrying a topographic map anywhere from one quarter to one sixteenth of its original size depending on the usage. And permitting the reader to merely flip the protected topographic map would provide extreme benefits to time management, safety and many other items related to a field mission. As described below, nothing else compares to the unique aspects of the present invention.

U.S. Pub. No. US 2005/0052015 on Mar. 10, 2005 invented by Hynek, is a device that relies on waterproof material and magnetic covers in order to protect individual pages of a book in an accordion-style form. Unlike the present invention, this device is limited strictly to book-type documents and is not designed to accommodate such large-format documents as topographic maps.

U.S. Pub. No. US 2005/0023819 on Feb. 3, 2005 invented by Wilen, is a device that relies on a cover and booklet pages in order to provide overlays and cover for various pages. Unlike the present invention, this device is not waterproof and is limited to pages with folded overlays and is not designed to accommodate such large-format documents as topographic maps.

A need has been established for a folding, waterproof topographic map cover specifically designed for USGS topographic maps and other large-format documents. It is not enough to laminate these types of large-format documents. Readers using a topographic map need to be able to easily flip to the desired quadrant of the topographic map in an efficient and practical manner, and lamination is irreversible; while folding is not. It is vital for a reader during a field mission to carry a topographic map that remains compact, dry, flat and readily accessible. Without these requirements, the topographic map becomes burdensome to maintain and susceptible to the elements. By exposing the topographic map to these elements, it also places the reader at a distinct tactical advantage. Because of these requirements, there is a great need to provide topographic map readers with a folding, waterproof cover that is much smaller in size but at the same time can make the topographic map easy to read by merely flipping between quadrants. The present invention satisfies these needs because it provides full protection to USGS topographic maps and other large-format documents in regard to the elements. In addition, the present invention makes it possible for a reader to quickly use the topographic map by merely folding the topographic map in the proper fashion and placing it under the protection of the present invention. The same goes for other items such as blueprints, poster-sized brochures and technical drawings. Therefore, the present invention satisfies the need for readers to protect and easily read their topographic maps or other large-format documents.

### SUMMARY OF THE INVENTION

The present invention consists of a rectangular apparatus featuring four transparent corner pockets used to hold a large-format document in place. While blueprints, poster-sized brochures and technical drawings can be used in conjunction with the present invention, a perfect example of the type of large-format document to be used is a USGS topographic map. Once this large-format document is fitted into place under the confines of the present invention, it is folded and scored in such a way that its viewable area one quarter its unfolded size.

In regard to USGS topographic maps, they are divided into four quadrants: northwest, southwest, northeast and southeast. When the topographic map is properly folded, each quadrant will be cordoned off into its own section. The topographic map is then placed into each of the four transparent corner pockets of the present invention one quadrant at a time. Once all four of the quadrants are fitted into the pockets of the present invention, the material of the present invention protects the topographic map. In addition, the present invention is transparent where it covers the topographic map. The four transparent pockets—one in each corner of the present invention—hold the topographic map in place. Lines moving both down the vertical center line and across the horizontal axis facilitate in the folding process. By flipping through the quadrant pages, one can then access each quadrant. When the topographic map is folded properly to fit the present invention, it is one-quarter the original size. When the present invention is completely closed, the topographic map is one-sixteenth the original size of the topographic map.

### BRIEF DESCRIPTION OF THE DRAWINGS

FIG. 1 is a diagram of the present invention while unfolded.

FIG. 2 is a chart detailing the steps taken to properly fold a USGS topographic map and integrate it with the present invention.

### DESCRIPTION OF THE PREFERRED EMBODIMENT

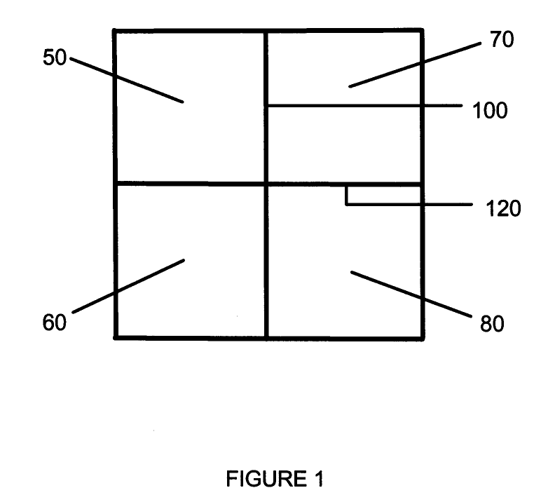

In FIG. 1, we see the present invention as it looks while unfolded and empty of a topographic map. However, it is important to note that while the example is that of a USGS topographic map, other large-format documents such as blueprints, poster-sized brochures and technical drawings also can apply to the present invention in much the same manner.

The present invention as seen in FIG. 1 has four quadrants featuring corner pockets for each quadrant—northwest quadrant pocket (50), southwest quadrant pocket (60), northeast quadrant pocket (70) and southeast quadrant pocket (80). The pockets are transparent for more efficient reading coupled with the secured function of these elements of the present invention. In addition, the present invention is designed to be foldable. As shown in FIG. 1, the present invention folds based on the vertical center line (100) and the horizontal axis (120).

The present invention, as seen in FIG. 1, is a rectangular apparatus made of durable material such as vinyl. As mentioned above, the present invention contains four transparent corner pockets that are used to hold the large-format document in place. This large-format document can be a USGS topographic map, or other like-sized document such as a blueprint or technical drawing or schematic. Once the large-format document is secured by the four corner pockets (50,60,70,80), the present invention can be folded twice based on the vertical center line (100) and the horizontal axis (120).

Once the large-format document is secured by the four corner pockets (50, 60, 70, 80) of the present invention, and the apparatus is folded twice, the present invention can now be used in relation to its primary function. At this juncture, the user can simply flip between the four quadrants in an easy and quick fashion instead of being forced to fold and unfold, or roll and unroll a large-format document. Meanwhile, when the cover element of the present invention is opened, the corner pockets keep the large-format document securely attached to the present invention.

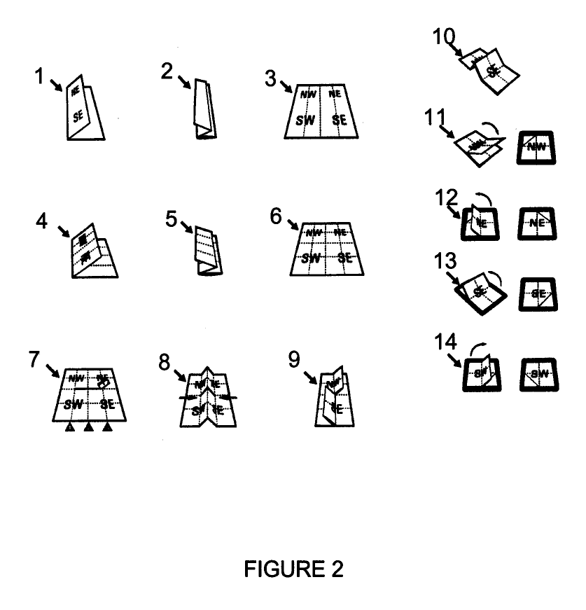

In FIG. 2, we see a numbered chart. This chart takes us step by step on how a USGS topographic map is specially folded in order to compliment the present invention. As FIG. 2 further demonstrates, the chart continues to provide instruction as to how the topographic map is inserted and ultimately put to use with the present invention. The example shown in FIG. 2 relates to USGS topographic maps. However, other large-format documents also can be used in conjunction with the present invention in essentially the same fashion.

To summarize what is already shown in FIG. 2, steps 1 through 10 of FIG. 2 explain how the topographic map should be folded. Notice that a cutting device is necessary in step 7 to cut a slit along the center crease line between the northern and southern halves of the map. Step 11 begins the process of actually inserting the folded topographic map into the present invention. In step 11, the northwest quadrant of the topographic map is first inserted into the northwest quadrant pocket (50) of the present invention. Step 12 describes how the northeast quadrant pocket (70) of the present invention is turned and made available for the northeast quadrant of the topographic map. Step 13 and step 14 go through the instruction for inserting the southwest and southeast portions of the topographic map into the present invention.

Once steps 1 through 14 are completed, the present invention can then be used to flip easily from quadrant to another. For example, if the northwest quadrant of the topographic map is in view and the reader wants to quickly look into the southeast quadrant of the topographic map, he or she simply flips the present invention to where the southeast quadrant pocket (80) is showing. Once the reader does this, he or she will be able to view the southeast quadrant of the topographic map in an unobstructed and visible manner. If the reader wants to then view the northeast quadrant of the topographic map, he or she simply flips the present invention to where the northeast quadrant pocket (70) is showing. This point will be the same as the previous example in that the northeast quadrant of the topographic map will be unobstructed and visible to the user.

The present invention also serves to close to provide even better space efficiency. When the reader wants to close the present invention and minimize its size impact, he or she first folds the present invention across at the vertical line (100) and lines it up like a standard book. Then, the reader folds the present invention at the horizontal axis (120) and lines it up like a standard flip pad. A window on the front cover can permit a card or other type of writing material to be inserted into the present invention in order to label the specific topographic map or other large-format document.

It also should be noted that the present invention is made of a flexible but durable material such as vinyl. In addition, the present invention is transparent. These additional elements of the present invention serve to provide the reader with an unencumbered and protected USGS topographic map that is easy to read and without the hassle traditionally associated with topographic map reading. In relation to the other practical elements of the present invention, the reader simply flips from quadrant to quadrant until he or she finds the desired area. The present invention equips the reader with an important and efficient tool as he or she engages in often difficult and vastly detailed navigation.

A preferred embodiment of the present invention is a device for holding large-format documents having a main body, four corners, a means at each of the four corners for securing a large-format document, at least one foldable region on the main body, at least one foldable region with two lines, two lines that are perpendicular to one another, two lines dividing said main body into four quadrants, said four quadrants is two small quadrants and two large quadrants, two lines bisecting one another, two lines is a wide line and a narrow line, two small quadrants side-by-side, two large quadrants side-by-side, two small quadrants separated by a wide line and two small quadrants separated by said wide line.

It is to be understood that the present invention is not limited to the sole embodiment described above, but encompasses any and all embodiments within the scope of the claims.

I claim:

1. A device for holding large-format documents comprising:
a main body, having four corners;
a means at each of said four corners for securing a large-format document; and
at least one foldable region on said main body.

2. The device for holding large-format documents according to claim 1, wherein said at least one foldable region is two lines.

3. The device for holding large-format documents according to claim 2, wherein said two lines are perpendicular to one another.

4. The device for holding large-format documents according to claim 2, wherein said two lines divide said main body into four quadrants.

5. The device for holding large-format documents according to claim 4, wherein said four quadrants is two small quadrants and two large quadrants.

6. The device for holding large-format documents according to claim 3, wherein said two lines divide said main body into four quadrants.

7. The device for holding large-format documents according to claim 3, wherein said two lines bisect one another.

8. The device for holding large-format documents according to claim 2, wherein said two lines is a wide line and a narrow line.

9. The device for holding large-format documents according to claim 1, wherein said at least one foldable region divides said main body into four quadrants.

10. The device for holding large-format documents according to claim 9, wherein said at least four quadrants is two small quadrants and two large quadrants.

11. The device for holding large-format documents according to claim 1, wherein said at least one foldable region has two regions that are perpendicular to one another.

12. The device for holding large-format documents according to claim 1, wherein said at least one foldable region divides said main body into four quadrants.

13. The device for holding large-format documents according to claim 1, wherein said at least one foldable region divides said main body into two small quadrants and two large quadrants.

14. The device for holding large-format documents according to claim 5, wherein said two small quadrants are side-by-side.

15. The device for holding large-format documents according to claim 5, wherein said two large quadrants are side-by-side.

16. The device for holding large-format documents according to claim 14, wherein said two lines is a wide line and a narrow line.

17. The device for holding large-format documents according to claim 15, wherein said two lines is a wide line and a narrow line.

18. The device for holding large-format documents according to claim 16, wherein said two small quadrants are separated by said wide line.

19. The device for holding large-format documents according to claim 17, wherein said two small quadrants are separated by said wide line.

20. A device for holding large-format documents comprising:
a main body, having four corners;
a means at each of said four corners for securing a large-format document; and
at least one foldable region on said main body;
wherein said at least one foldable region is two lines;
wherein said two lines are perpendicular to one another;
wherein said two lines divide said main body into four quadrants;
wherein said four quadrants is two small quadrants and two large quadrants;
wherein said two lines bisect one another;
wherein said two lines is a wide line and a narrow line;
wherein said two small quadrants are side-by-side;
wherein said two large quadrants are side-by-side;
wherein said two small quadrants are separated by said wide line; and
wherein said two small quadrants are separated by said wide line.
